(19) United States
(12) Patent Application Publication
(10) Pub. No.: US 2015/0313690 A1
(43) Pub. Date: Nov. 5, 2015

(54) DENTAL DEVICE FIXING UNIT SECURED RESILIENTLY INTO IMPLANTS AND/OR DENTAL DEVICE FIXING UNIT SECURED INTO IMPLANTS ENABLING OPTIONAL ANGULAR POSITION ADJUSTMENT

(71) Applicant: Edvin Elsner, Szigetszentmiklos (HU)

(72) Inventor: Edvin Elsner, Szigetszentmiklos (HU)

(21) Appl. No.: 14/650,308

(22) PCT Filed: Jan. 3, 2014
(86) PCT No.: PCT/HU2014/000001

§ 371 Date: Jun. 7, 2015

(30) Foreign Application Priority Data
Jan. 7, 2013 (HU) P1300005
Mar. 7, 2013 (HU) P1300140

(51) Int. Cl. A61C 8/00

(52) U.S. Cl. CPC A61C 8/0053; A61C 8/0074; A61C 8/0054; A61C 8/0089; A61C 8/006; A61C 8/0057

(57) ABSTRACT

Dental device fixing unit (3) which can be secured resiliently into a dental implant enabling optional angular position adjustment comprising a threaded shank (4) tiltable in all direction projecting from the implant (2) and a fixing element (5) for securing the threaded shank (4) to the implant (2). The fixing element (5) consists of an insertion piece (6) and an intermediate piece (7) provided with a bore-hole (14) in which the threaded shank (4) is led through in order to secure the insertion piece (6) to the implant (2). The end (9) of the insertion piece (6) and the inner end (8) of the threaded shank (4) are attached to each other in a swivelable manner. The inner end (8) of the threaded shank (4) is positioned between the end (9) of the insertion piece (6) and the upper end (13) of the intermediate piece (7).

The invention relates to a dental device fixing unit which can be secured advantageously resiliently into a dental implant and the angular position of the fixing unit can be adjusted optionally. The fixing unit comprises a threaded shank tiltable in all direction projecting from the implant and a fixing element for securing the threaded shank to the implant. The fixing element consists of an insertion piece and an intermediate piece provided with a bore-hole in which the threaded shank is led through in order to secure the insertion piece to the implant. The end of the insertion piece and the inner end of the threaded shank are attached to each other in a swivelable manner. The inner end of the threaded shank is positioned between the end of the insertion piece and the upper end of the intermediate piece.

In case of dental prosthesis there is a growing demand to provide crowns, bridges which can be attached (screwed) to dental implants in a releasable manner. Dental superstructures which can be screwed into implants upright or in a determined angle by means of which dental devices can be built in through screwed connection can also be used in case of all types of implants in which screwed connection is practically unrealizable because after mounting them in the jaw-bone, the angle included by the implants is greater than the internal cone angle (1-30°). As the position of the implants is determined by the bony substance, divergence of the implants (can be more than 50°) is a frequent problem.

It often happens that a missing tooth of the patient is replaced but the implant used by the dentist is not adapted for receiving the fixing screw of a bridgework if it is needed later.

Patent application U.S. Pat. No. 5,116,225 describes an angulated abutment system for affixing a dental prosthesis to an anchor implanted in the jaw bone. The dental prosthesis can be mounted axially offset from the axis of the implant. Two components of the abutment system allow the dental prosthesis to be adjusted in small angles of rotation.

This solution also takes measures to fix the superstructure at the side facing the oral cavity, but it uses number of components production of which is complicated. Although the channel is formed straight, producing the opening from the direction of the implant is complicated because of the number of intermediate component parts.

Patent application WO 2008/138852 describes an adapter for a dental implant with a conical connection recess in its upper part. The adapter comprises a threaded part for connection with the dental implant and a conical main body corresponding to a conical connection recess of the implant, a tool grip portion allowing for attachment of the adapter to the implant by the aid of a tool, and a connection recess adapted for connection to a spacer element or a dental structure.

In this solution the spacer is provided with outer and inner threads which on the one hand is fixed in the implant, on the other hand the superstructure is fixed in it. Typically, this type of spacer is not used in our days since in recent times the superstructure is screwed directly into the implant. For the sake of proper positioning of the superstructure a suitable interface may be installed between the implant and the superstructure.

In these solutions adjustment of the angle (0, 15, 20, 25 degree) is predetermined by the manufacturer.

Patent application U.S. Pat. No. 4,842,518 describes a submergible screw-type implant. In order to be able to position the implant at the most advantageous angle, angled abutments for supporting an artificial tooth structure or angularly adjustable abutments are provided. The angularly adjustable abutments may be in the form of a ball and socket joint in which the socket includes an inner casing having a peripheral extension that acts to lock the joint at the desired angle.

In this solution the fixing screw at the ball joint leans against the contralateral side of the sphere shell, consequently swivel of the superstructure is prevented by the frictional force. The outer surface of the implant is not supported securely.

Patent application U.S. Pat. No. 6,358,052 describes a dental implant system and method for effecting a dental restoration. The dental implant system having an implant fixture adapted to be deployed in a bone; an impression coping adapted to be selectively deployed on the implant fixture and in a dental impression; a laboratory analog adapted to be selectively deployed on the impression coping and in a dental cast; a spherical abutment adapted to be selectively deployed on the laboratory analog; and a multiaxis abutment adapted to be adjustably deployed on the spherical abutment; wherein the spherical abutment and the multiaxis abutment are used to generate a cast permanent abutment which may be received by the laboratory analog and the implant fixture.

Patent application EP 1621156A1 teaches an implant system including an implant for implanting into a bone; an abutment to serve as a support for fixing a prosthesis to the bone; and a pivotal coupling between the implant and the abutment to permit, after the implant has been implanted into the bone, precise angulation in all directions of the abutment with respect to the implant before the abutment is fixed at the desired precise angulation with respect to the implant.

However, to fix the position, additional steps must be taken since gluing or welding process is needed to it.

In patent application WO 2012/142517 A2 a dental system is described, including a lower implant body configured to be implanted in bone, and an upper implant body that couples to the lower body, thereby forming a cavity between upper and lower bodies. The system can further include a rotatable, swivelable anchor having a base at least partially disposed within the cavity. The anchor may have a shaft coupled to the base and extending through an opening in the upper body. The system may also include an abutment that couples to the shaft of the anchor and serves as a mounting area for a crown. The anchor's rotatability and swivelability allow the lower implant body to be implanted at an angle in bone while permitting the crown to be positioned in a natural tooth orientation.

Here, swivel of the implant is prevented by a disc-spring therefore it is difficult to release the screw-joint. Further, if the disc-spring gets worn-out, the implant is able to swivel. Stable support of the superstructure is not ensured by the sphere-shaped surface of the upper end of the intermediate piece. Moreover, bacteria can get in easily.

In certain cases the spherical end of the threaded shank is accommodated in a spherical seat. Then it is the task of the disc-spring to prevent the swivel of the implant through frictional force. In other cases the ball joint is provided at the upper end of the lower implant.

The present invention does not relate to an implant, it rather relates to a dental device fixing unit secured into the implant the angular position of which can be adjusted optionally. There is a significant difference between the two since in case of an implant the product can be used for a given implant type while the dental device fixing unit according to the present invention can be built in any type of implants. It leans against a flat surface instead of a spherical shell. When certain component parts or the whole appliance must be replaced, the appliance can be removed without the need of drastic extraction of the implant from the jaw-bone which is necessary in case of implants having a ball and socket joint. Its massive structure ensures increased life span as compared to the implants nowadays available on the market.

Implants for replacing one or more missing teeth have been successfully used in dentistry for more than 20 years. The implant fuses to the bone, however, it will not be as resilient as a real (living) tooth. A tooth is connected to the bone through Sharpey's fibres ensuring shock-absorption which cannot be ensured by implants. The forces applied from the opposing teeth are transmitted to the jaw bone without damping causing a disturbing effect for the patients. Consequently, there is a need for implants which are fixedly secured in the bone while the dental device built on it is slightly resilient and able to move to a small extent therefore is capable for damping. The aim of the present invention is to provide an implant which is fixedly mounted in the bone, while the dental device built on it has vibration damping features as it is slightly resilient towards the bone and makes minor movement of the dental device possible. A further aim is to make mounting of the implant and the dental device (comprising one or more teeth) easier.

It has been realized that if surgical silicone is placed between the implant and the dental device fixing element than the dental device will have vibration damping features and resilience towards the bone. Through this solution sealing is provided between the implant and the superstructure thereby occurrence of a so called bacteria pump originating from the micro movement is prevented and bacteria cannot get inside the implant.

It has also been realized that as opposed to known ball mechanisms a more stable and durable ball mechanism can be provided through which the dental device can be fixed in the mouth so that its angular position can be adjusted relative to the direction of the implant. Further, a more aesthetic appearance can be provided as the bore-holes of the screws are hidden in the oral cavity. The centre of rotation of the portion of the fixing unit joining to the dental device lies in the central point of the abutting platform of the implant thereby the position of the bore-hole in the dental device can be easily determined.

Accordingly, the present invention provides a dental device fixing unit which can be secured resiliently into an implant built in the periodontium enabling optional angular position adjustment. The dental device fixing unit comprises a threaded shank tiltable in all direction projecting from the implant and a fixing element for securing the threaded shank to the implant. The fixing element consists of an insertion piece and an intermediate piece provided with a bore-hole in which the threaded shank is led through in order to secure the insertion piece to the implant. The end of the insertion piece and the inner end of the threaded shank are attached to each other in a swivelable manner. The inner end of the threaded shank is positioned between the end of the insertion piece and the upper end of the intermediate piece. The fixing unit is secured to the implant by screw joint in such a manner that the core diameter of the threads provided on the intermediate piece is at least 0.1 mm less than the nominal diameter of the female threads provided in the implant. Advantageously, prior to plating the implant—provided with the fixing unit—in the periodontium, vulcanized, biocompatible silicone is filled between the intermediate piece and the implant.

In another aspect the present invention provides a dental device fixing unit which can be secured resiliently into an implant built in the periodontium enabling optional angular position adjustment. The dental device fixing unit comprises a threaded shank projecting from the implant and a fixing element for securing the threaded shank to the implant. The fixing element consists of an insertion piece and an intermediate piece. In one embodiment of the dental device fixing unit according to the invention the end of the insertion piece is semi-spherical. The inner end of the threaded shank is a sphere shell the inner spherical surface of which is widened towards the insertion piece. The cross-section of its outer spherical surface perpendicular to the axis of rotation of the threaded shank is a regular polygon, advantageously hexagon that follows the curvature of the sphere. The inner surface of the intermediate piece is a sphere-like shell whose cross-section perpendicular to the axis of symmetry of the intermediate piece is a regular polygon that follows the curvature of the sphere-like shell, the number of the angles of the polygon equals to the number of the angles of the regular polygon formed at the inner end of the threaded shank. In the surface of the intermediate piece opposite the implant a bore-hole is provided in which the threaded portion of the threaded shank is led through. The inner end of the threaded shank is placed between the inner surface of the intermediate piece and the end of the insertion piece. The intermediate piece and the insertion piece are attached to each other in a releasable or un-releasable manner so that tight but tiltable movement of the threaded shank is ensured. The fixing unit is secured in the implant preferably in a releasable manner.

In another embodiment of the dental device fixing unit the end of the insertion piece is flat. The inner end of the threaded shank forms a sphere-like body whose cross-section perpendicular to the axis of rotation of the threaded shank is a regular polygon advantageously hexagon that follows the curvature of the sphere. The inner surface of the intermediate piece is a sphere-like shell whose cross-section perpendicular to the axis of symmetry of the intermediate piece is a regular polygon that follows the curvature of the sphere-like shell, the number of the angles of the polygon equals to the number of the angles of the regular polygon formed at the inner end of the threaded shank. In the surface of the intermediate piece opposite the implant a bore-hole is provided in which the threaded portion of the threaded shank is led through. The inner end of the threaded shank is placed between the inner surface of the intermediate piece and the end of the insertion piece. Advantageously, between the inner end of the threaded shank and the end of the insertion piece vulcanized, biocompatible silicone is filled. The intermediate piece, the insertion piece and the threaded shank are attached in a manner described in the foregoing.

In a further embodiment of the dental device fixing unit according to the invention the inner end of the threaded shank is formed as a sphere-like body, at least the portion of it facing the dental device is formed as a regular sphere. Perpendicular to the axis of rotation of the threaded shank the cross-section of the portion of the inner end facing the implant is a regular polygon advantageously hexagon that follows the curvature of the sphere. The inner surface of the intermediate piece forms a sphere shell. At the end of the insertion piece a sphere shell-like seat is formed whose cross-section perpendicular to the axis of symmetry of the insertion piece is a regular polygon, the number of the angles of the polygon equals to the number of the angles of the regular polygon formed at the inner end of the threaded shank near the implant. In the surface of the intermediate piece opposite the implant a bore-hole is provided in which the threaded portion of the threaded shank is led through. The inner end of the threaded shank is placed between the inner surface of the intermediate piece and the end of the insertion piece. The intermediate piece and the insertion piece are attached to each other in a releasable or un-releasable manner so that tight but tiltable movement of the threaded shank is ensured. The fixing unit is secured in the implant preferably in a releasable manner.

Preferred embodiments of the invention will be defined by the appended claims. Detailed description of the invention will be given with reference to the accompanying drawings in which:

FIGS. 1-8 show the design of the fixing unit before insertion and in which silicone is used for its resilient placement according to the invention, in which:

FIG. 1 is the sectional side view of the implant provided with a channel for receiving the fixing unit,

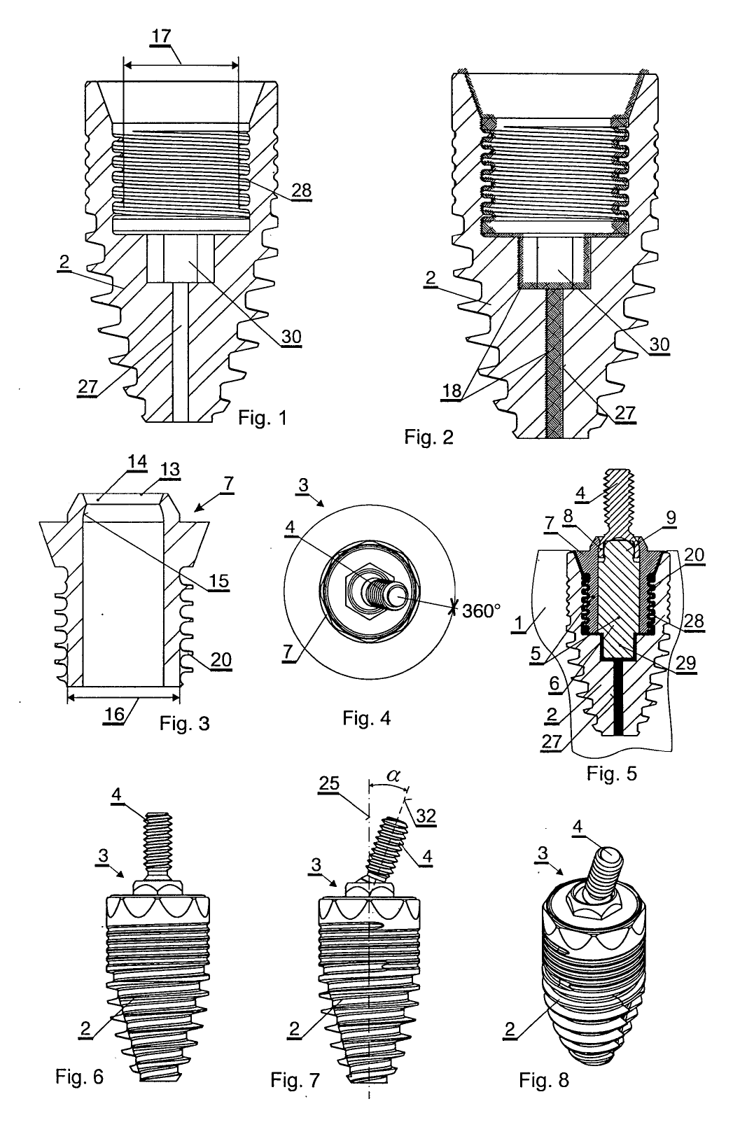

FIG. 2 is the sectional side view of the implant showing the arrangement of the silicone as if the fixing unit were placed in the implant;

FIG. 3 is the sectional side view of the intermediate piece the core diameter of which is chosen suitably to the silicone filling,

FIG. 4 is the plan view of an implant provided with the fixing unit in which the threaded shank is set divergent from the vertical direction;

FIG. 5 is the sectional side view of the fixing unit secured resiliently in the implant;

FIG. 6 is the side view of the implant provided with the fixing unit;

FIG. 7 is the side view of the implant provided with the fixing unit in which the threaded shank is set divergent from the vertical direction;

FIG. 8 is the perspective view of the implant provided with the fixing unit in which the threaded shank is set divergent from the vertical direction;

FIGS. 9-23 show the embodiment of the fixing unit according to our first invention in which:

FIG. 9 is the bottom view of the intermediate piece shown in FIG. 10 according to our first invention;

FIG. 10 is the side view of the intermediate piece according to our first invention;

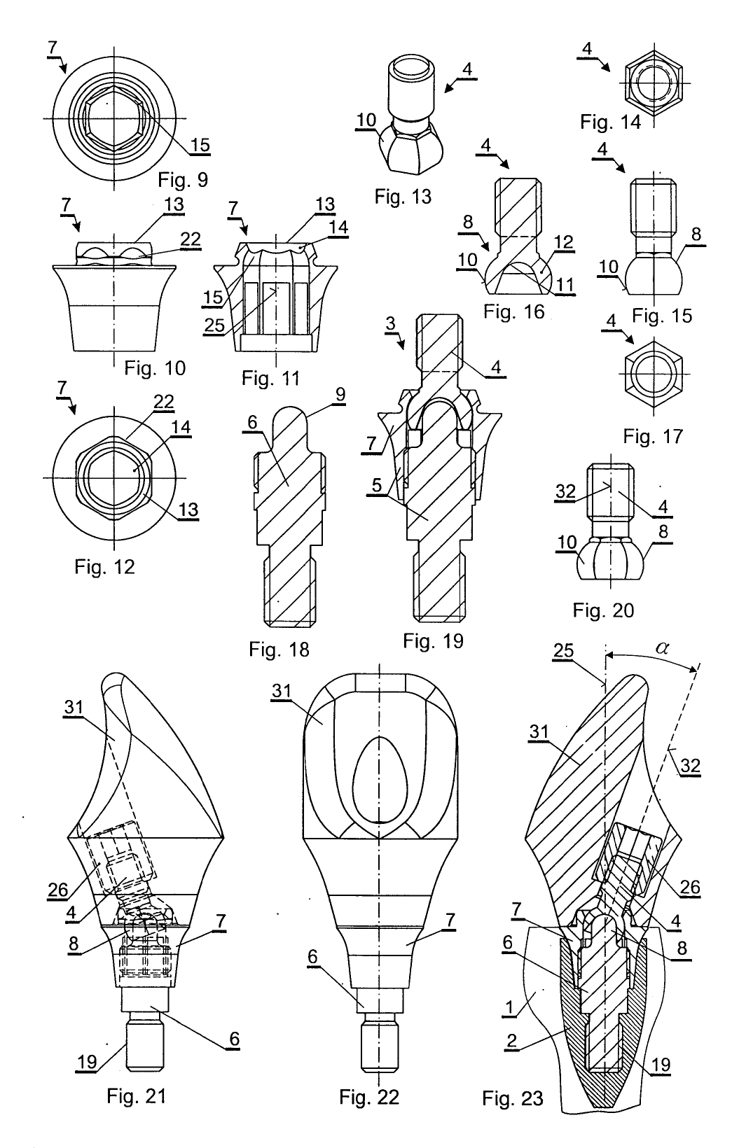

FIG. 11 is the sectional side view of the intermediate piece of FIG. 10;

FIG. 12 is the plan view of the intermediate piece of FIG. 10;

FIG. 13 is the perspective view of the threaded shank joining in the intermediate piece of FIG. 10;

FIG. 14 is the bottom view of the threaded shank of FIG. 13;

FIG. 15 is the side view of the threaded shank of FIG. 13;

FIG. 16 is the sectional side view of the threaded shank of FIG. 15;

FIG. 17 is the plan view of the threaded shank of FIG. 13;

FIG. 18 is the sectional side view of the insertion piece;

FIG. 19 is the sectional side view of the fixing unit;

FIG. 20 is the sectional side view of the threaded shank of FIG. 15 rotated by 30°;

FIG. 21 is the X-ray drawing of the dental device mounted on the fixing unit,

FIG. 22 is the rear view of the embodiment shown in FIG. 21;

FIG. 23 is the sectional side view of the embodiment shown in FIG. 22 when it is built in the implant.

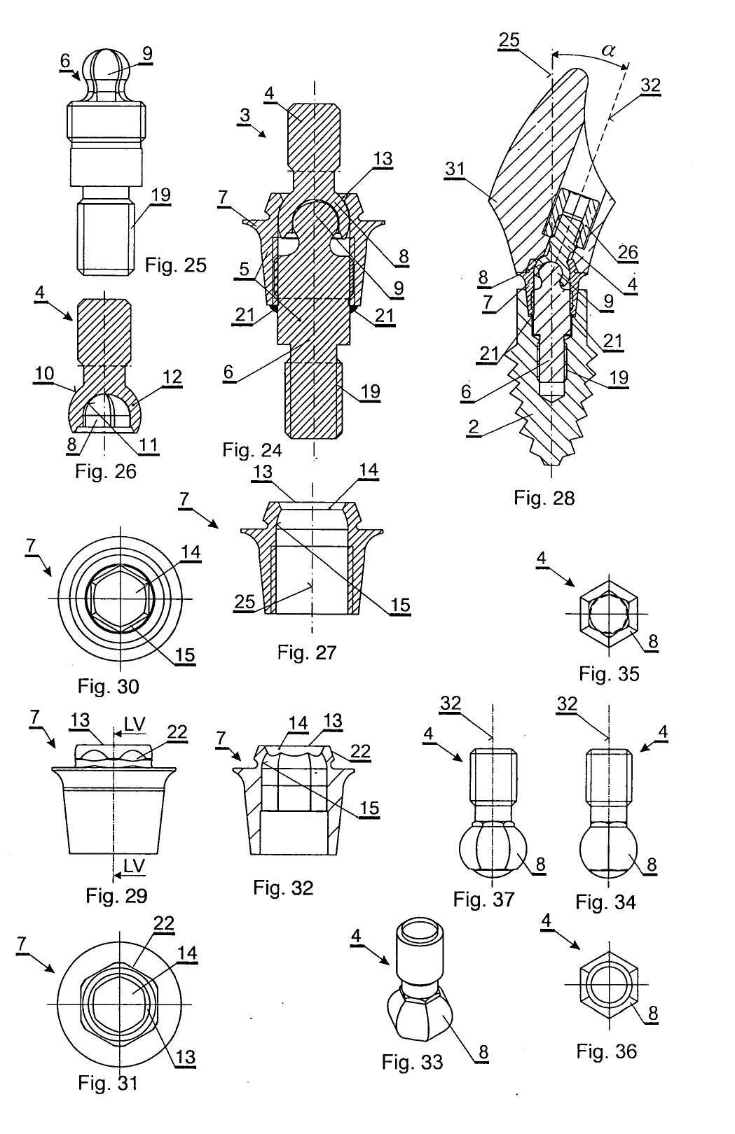

FIGS. 24-28 show an embodiment of the invention in which the intermediate piece is fixed in the implant as a fixing element rather than to the implant ensuring removability of the fixing unit.

FIG. 24 is a sectional side view of an embodiment of the fixing unit comprising the insertion piece, the threaded shank and the intermediate piece;

FIG. 25 is the side view of the insertion piece shown in FIG. 24;

FIG. 26 is the sectional side view of the threaded shank shown in FIG. 24;

FIG. 27 is the sectional side view of the intermediate piece shown in FIG. 24;

FIG. 28 is the sectional side view of the fixing unit according to FIG. 24 built in the implant and provided with the dental device.

FIGS. 29-47 show the embodiment of the fixing unit according to our second invention in which:

FIG. 29 is the side view of the intermediate piece according to our second invention;

FIG. 30 is the bottom view of the intermediate piece of FIG. 29;

FIG. 31 is the plan view of the intermediate piece of FIG. 29;

FIG. 32 is the sectional side view of the intermediate piece of FIG. 29;

FIG. 33 is the perspective view of the threaded shank joining in the intermediate piece of FIG. 29;

FIG. 34 is the side view of the threaded shank of FIG. 33;

FIG. 35 is the bottom view of the threaded shank of FIG. 34;

FIG. 36 is the plan view of the threaded shank of FIG. 34;

FIG. 37 is the sectional side view of the threaded shank of FIG. 34 rotated by 30°;

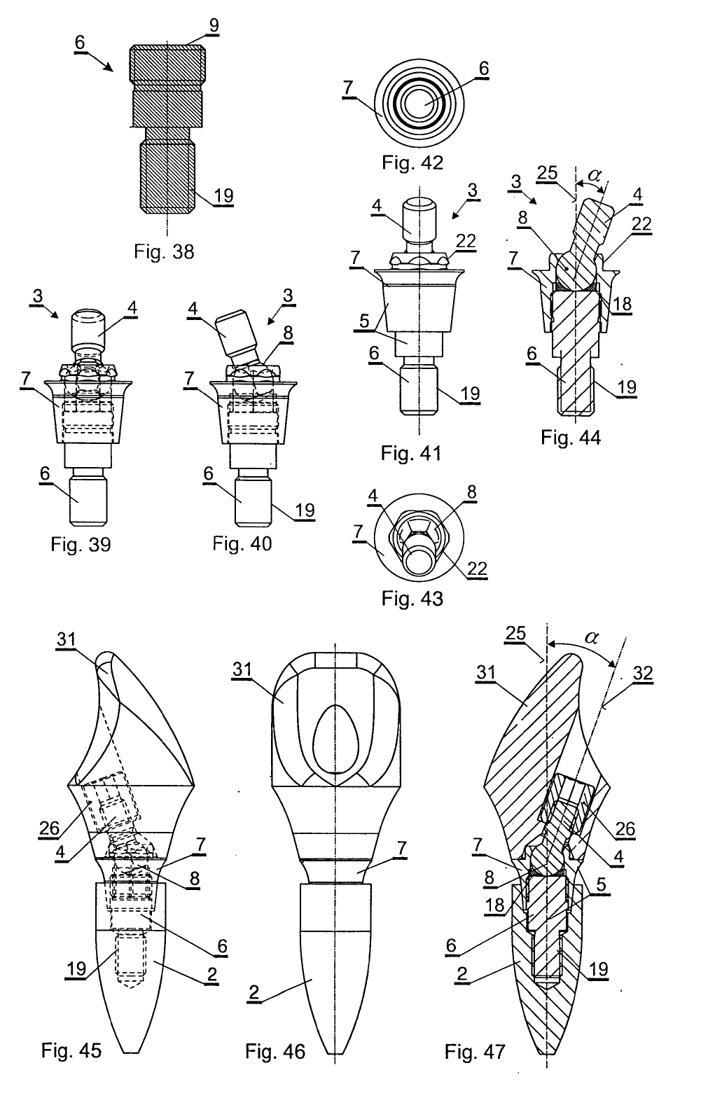

FIG. 38 is the sectional side view of the insertion piece;

FIG. 39 is the front-wise X-ray drawing of the fixing unit with a tilted threaded shank;

FIG. 40 is the X-ray drawing of the fixing unit of FIG. 39 with a tilted threaded shank as viewed from the side;

FIG. 41 is the front view of the fixing unit with a tilted threaded shank;

FIG. 42 is the bottom view of the fixing unit of FIG. 41;

FIG. 43 is the plan view of the fixing unit of FIG. 41;

FIG. 44 is the sectional side view of the fixing unit of FIG. 41 in which the silicone bed is also shown,

FIG. 45 is the X-ray drawing of the dental device mounted on the fixing unit inserted in the implant as viewed from the side;

FIG. 46 is the rear view of the embodiment of FIG. 45;

FIG. 47 is the sectional side view of the embodiment of FIG. 46.

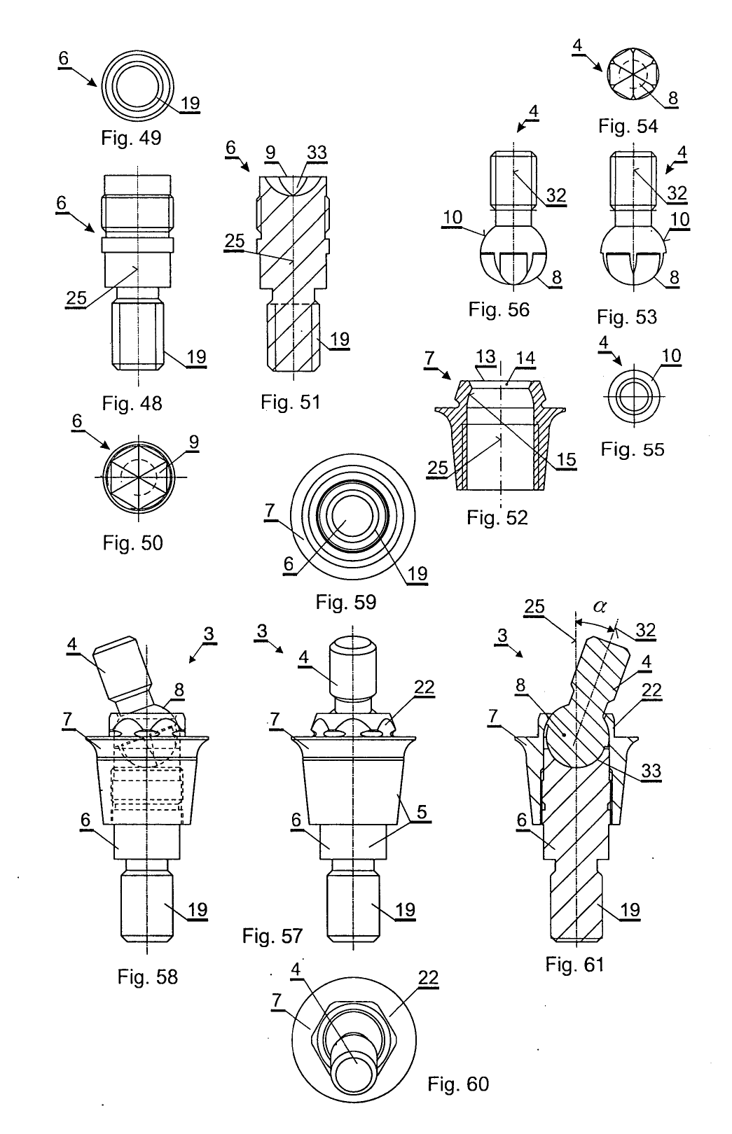

FIGS. 48-64 show an embodiment of the fixing unit according to our third invention in which:

FIG. 48 is the side view of the insertion piece according to our third invention;

FIG. 49 is the bottom view of the insertion piece of FIG. 48;

FIG. 50 is the plan view of the insertion piece of FIG. 48;

FIG. 51 is the sectional side view of the insertion piece of FIG. 48;

FIG. 52 is the sectional side view of the intermediate piece according to our third invention;

FIG. 53 is the side view of the threaded shank according to our third invention,

FIG. 54 is the bottom view of the threaded shank of FIG. 53;

FIG. 55 is the plan view of the threaded shank of FIG. 53;

FIG. 56 is the sectional side view of threaded shank of FIG. 53 rotated by 30°;

FIG. 57 is the side view of the fixing unit composed from the elements shown in FIGS. 48-56;

FIG. 58 is the X-ray drawing of the fixing unit of FIG. 57 as viewed from the side;

FIG. 59 is the bottom view of the fixing unit of FIG. 57;

FIG. 60 is the plan view of the fixing unit of FIG. 57;

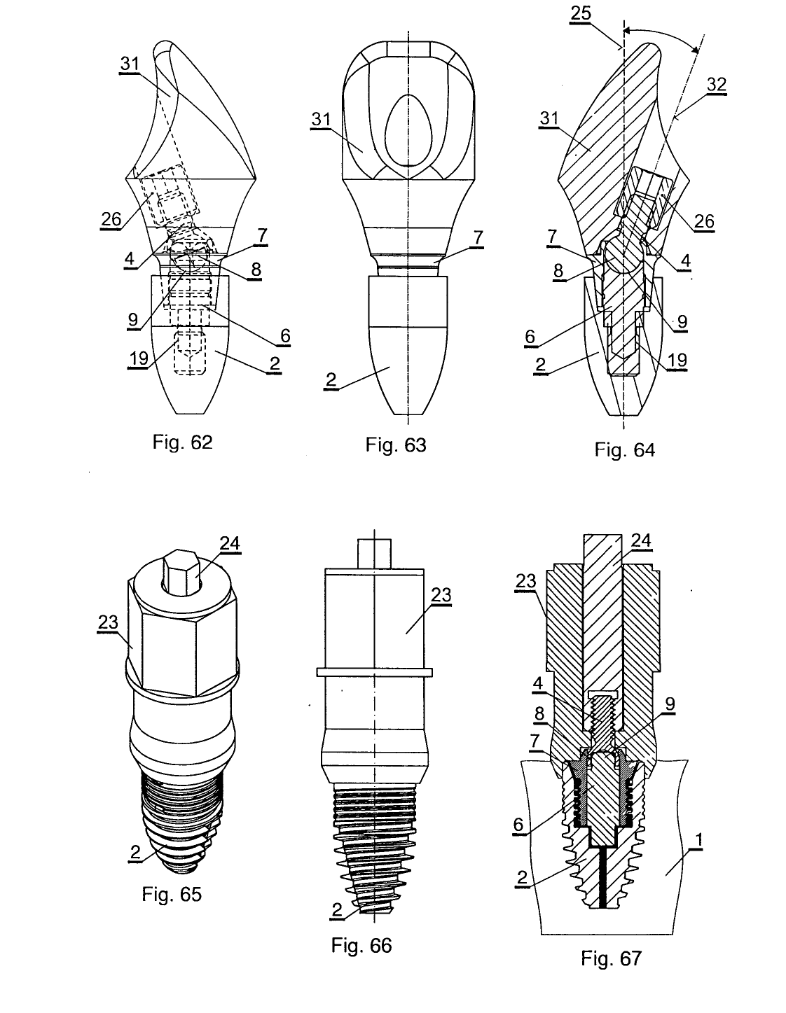

FIG. 61 is the sectional side view of the fixing unit of FIG. 57;

FIG. 62 is the X-ray drawing of the dental device mounted on the fixing unit installed in the implant as viewed from the side;

FIG. 63 is the rear view of the embodiment of FIG. 62;

FIG. 64 is the sectional side view of the embodiment of FIG. 63.

FIGS. 65-67 show the tool applicable for placing the implant provided with the fixing unit according to the invention in the periodontium:

FIG. 65 is the perspective view of the tool for placing the implant provided with the fixing unit in the periodontium;

FIG. 66 is the side view of the tool for placing the implant provided with the fixing unit in the periodontium;

FIG. 67 is the sectional side view of the tool for placing the implant provided with the fixing unit in the periodontium.

The present invention relates to fixing units 3 of various kinds. according to the invention each of these fixing units can be installed resiliently in any implants 2. To this surgical silicone 18 is placed between implant 2 and fixing element 5 of the dental device 31. In this manner dental device 31 built in the implant becomes slightly resilient and has damping feature in the periodontium 1. In addition, this solution ensures sealing between the fixing element 5 of the fixing unit 3 and the implant 2 so that occurrence of a so called bacteria pump originating from the micro movement is prevented and bacteria cannot get inside the implant 2.

To secure fixing unit 3 in implant 2 by means of resilient bio-compatible silicone 18 the solution according to FIG. 5 is used. FIG. 1 shows the design of the implant, FIG. 2 shows the position of the silicone 18 without the intermediate piece 7 in the case when intermediate piece 7 is in the implant. Intermediate piece 7 is secured in the implant 2 by screw joint in such a manner that the core diameter 16 of thread 20 provided on intermediate piece 7 is at least 0.1 mm less (advantageously 0.1-0.3 mm) than the nominal diameter 17 of the female thread 28 provided in the implant 2 (FIGS. 1 and 3). Prior to placement of the implant 2 provided with the fixing unit 3 in periodontium 1 bio-compatible silicone 18 is filled through channel 27 between intermediate piece 7 of fixing unit 3 and implant 2. Then silicone 18 is vulcanized (FIG. 5). Silicone 18 may be filled in any known manner even by omission of channel 27.

In FIGS. 4 and 6-8 the fixing unit 3 secured in the implant 2 by means of silicone (naturally, in this case it is not perceptible) can be seen.

Implant 2 joining in periodontium 1 has a special surface treated shell-structure provided with external threads in order to have as large surface as possible for engagement with the periodontium 1. On the inner surface of implant 2 female threads are provided and it is also surface treated. When bio-compatible silicone 18 is used the fixing unit 3 is placed essentially equidistant from the inner wall of the implant 2 in all direction. The gap between the two is filled in with surgical bio-compatible silicone 18 through channel 27 in order to ensure resilient connection between fixing unit 3 and implant 2. Silicone 18 reaches up to the upper part of implant 2 so that sealing between dental device 31 and implant 2 is ensured. In this manner occurrence of a so called bacteria pump originating from the micro movement is prevented and bacteria cannot get inside the implant 2.

With the present invention differently realized fixing units 3 for dental devices 31 are provided which can be secured in dental implant 2 built in periodontium 1. The fixing unit 3 comprises a threaded shank 4 projecting from the implant 2 and a fixing element 5 for securing the threaded shank 4 to implant 2. Mounting of fixing unit 3 and/or a fixing unit 3 assembled with implant 2 can be performed by means of a tool designed for this purpose which will be described later.

An embodiment of the fixing unit 3 according to our first invention can be seen in FIGS. 9-23. FIG. 19 shows the fixing unit 3 for securing dental device 31—the angular position of which is optionally adjustable—in implant 2 built in the periodontium 1 (FIGS. 21, 2 and 23). Fixing element 5 of fixing unit 3 comprises intermediate piece 7 and insertion piece 6 (FIG. 19). The end 9 of insertion piece 6 is hemispherical (FIG. 18). The inner end 8 of the threaded shank 4 (FIGS. 14-17) is a sphere shell 12 the inner spherical surface 11 of which is widened towards the insertion piece 6 (FIG. 16). The cross-section of its outer spherical surface 10 perpendicular to the axis of rotation 32 of the threaded shank 4 is a regular polygon, advantageously hexagon that follows the curvature of the sphere (FIGS. 20 and 13). The inner surface 15 of the intermediate piece 7 (FIGS. 9-12) is a sphere-like shell whose cross-section perpendicular to the axis of symmetry 25 of the intermediate piece 7 is a regular polygon that follows the curvature of the sphere-like shell, the number of the angles of the polygon equals to the number of the angles of the regular polygon formed at the inner end 8 of the threaded shank 4 (FIG. 11). In the surface of the intermediate piece 7 opposite the implant 2 a bore-hole 14 is provided in which the threaded portion of the threaded shank 4 is led through (FIG. 19). The inner end 8 of the threaded shank 4 is placed between the inner surface 15 of the intermediate piece 7 and the end 9 of the insertion piece 6 (FIGS. 19, 23). The intermediate piece 7 and the insertion piece 6 are attached to each other through releasable or un-releasable joint 21 so that tight but tiltable movement of the threaded shank 4 is ensured. The fixing unit 3 is mounted in the implant 2 preferably in a releasable manner (FIG. 23). FIGS. 21 and 22 show the engagement between fixing unit 3 and dental device 31. The implant is not shown in these Figures. During mounting fixing unit 3 is first placed in implant 2. This assembly is driven into periodontium 1 and the threaded shank 4 is set in the required direction. Then sample is taken and dental device 31 is made which is placed on threaded shank 4 and secured by means of the fixing female screw 26. This method of mounting can be applied in case of fixing units 3 according to each of our invention. In this solution the outer spherical surface 10 of threaded shank 4 is shaped similarly to the head of a rounded torx screwdriver or Allen-key or any polygonal screwdriver. The inner surface 15 of the intermediate piece 7 is provided with a spherical seat for receiving the outer spherical surface 10 of threaded shank 4.

FIGS. 24-28 show an embodiment according to the invention in which the intermediate piece 7 is secured to insertion piece 6 instead of implant 2 in order to ensure removability of fixing unit 3.

In this embodiment fixing unit 3 (FIGS. 24 and 28) comprises a threaded shank 4 projecting from implant 2 (FIG. 26) and a fixing element 5 which secures threaded shank 4 to implant 2 (FIG. 24). The solution shown in FIG. 24 can be used in case of each embodiment according to any one of the present inventions, when intermediate piece 7 (FIG. 27) is attached to insertion piece 6 (FIG. 25) through un-releasable joint 21, preferably welded joint. Fixing element 5 comprises insertion piece 6 and intermediate piece 7 (FIG. 24).

End 9 of insertion piece 6 is formed in such a manner that it fits into a spherical seat (FIG. 25). The inner end 8 of the threaded shank 4 facing implant 2 is shaped as a sphere shell 12 bordered by essentially concentric outer spherical surface 10 and inner spherical surface 11 which fits onto end 9 of insertion piece 6 (FIG. 26). The outer spherical surface 10 of sphere shell 12 is formed so that it fits to inner surface 15 provided with a bore-hole 14 (FIG. 27) and formed on the inner side of the upper end 13 of intermediate piece 7 (FIGS. 24 and 28).

The inner end 8 of threaded shank 4 driven through bore-hole 14 is placed between end 9 of insertion piece 6 and upper end 13 of intermediate piece 7 so that it fits to inner surface 15 of intermediate piece 7 (FIGS. 24 and 28).

Fixing unit 3 is secured in implant 2. This can be realized for example by threaded joint 19 formed at the end of insertion piece 6 projecting over intermediate piece 7 or by means of threads 20 provided on the outer surface of intermediate piece 7. In one embodiment fixing unit 3 is driven into implant 2 by means of threaded joint 19 provided on the leg of insertion piece 6. In this case insertion piece 6 and intermediate piece 7 are attached (e.g. welded) to each other through un-releasable joint 21 after insertion of the threaded shank 4 and before insertion of the fixing unit 3 (FIG. 24). In another embodiment (FIG. 5) the outer sheath of the intermediate piece 7 is provided with threads 20 by means of which fixing unit 3 is driven into female threads 28 formed in implant 2. (Although FIG. 5 shows the solution in which silicone is used, naturally it can be omitted if the connection between threads 20 and female threads 28 is tight enough. This embodiment is not shown in the Figures as it is obvious on the basis of the drawings.) The described fixing methods can be chosen and used in each of the solutions according to any one of the present inventions.

In this solution end 9 of insertion piece 6 is shaped similarly to the head of a rounded torx screwdriver or Allen-key or any polygonal screwdriver. The inner end 8 of the threaded shank 4 is provided with a spherical seat for receiving the end 9 of insertion piece 6.

In FIGS. 29-47 an embodiment of the fixing unit 3 according to our second invention can be seen.

In this embodiment the end 9 of the insertion piece 6 is flat (FIG. 38). The inner end 8 of the threaded shank 4 forms a sphere-like body whose cross-section perpendicular to the axis of rotation 32 of the threaded shank 4—at least at the hemispherical portion near the threaded part of the threaded shank 4—is a regular polygon advantageously hexagon that follows the curvature of the sphere. The portion of the inner end 8 opposite the threaded part of the threaded shank 4 forms a regular segment of a sphere, at most a hemisphere (FIGS. 33-37). The inner surface 15 of the intermediate piece 7 is a sphere-like shell whose cross-section perpendicular to the axis of symmetry 25 of the intermediate piece 7 is a regular polygon that follows the curvature of the sphere-like shell, the number of the angles of the polygon equals to the number of the angles of the regular polygon formed at the inner end 8 of the threaded shank 4 (FIGS. 29-32). In the surface of the intermediate piece 7 opposite the implant 2 a bore-hole 14 is provided in which the threaded portion of the threaded shank 4 is led through. The inner end 8 of the threaded shank 4 is placed between the inner surface 15 of the intermediate piece 7 and the end 9 of insertion piece 6 (FIGS. 39-44). Between the inner end 8 of the threaded shank 4 and the end 9 of the insertion piece 6 vulcanized, biocompatible silicone 18 is filled. In this manner a durable, tight enough and resilient connection is ensured. Intermediate piece 7 and insertion piece 6 are connected to each other through releasable or un-releasable joint 21 so that tight but tiltable movement of the threaded shank 4 is ensured (FIGS. 39-40). Fixing unit 3 is secured in implant 2 through releasable joint.

FIGS. 45-47 show the engagement between fixing unit 3 and dental device 31. During mounting fixing unit 3 is first placed in implant 2. This assembly is driven into periodontium 1 and the threaded shank 4 is set in the required direction. Then sample is taken in the known manner and dental device 31 is made which is then placed on threaded shank 4 and secured by means of the fixing female screw 26.

In this solution the inner end 8 of threaded shank 4 is shaped similarly to the head of a rounded torx screwdriver or Allen-key or any polygonal screwdriver. The inner surface 15 of the intermediate piece 7 is provided with a spherical seat for receiving the inner end 8 of threaded shank 4.

FIGS. 48-64 show an embodiment of the fixing unit according to our third invention. In this solution the inner end 8 of the threaded shank 4 is formed as a sphere-like body, at least the portion of it facing the threaded part of the threaded shank 4 is formed as a regular sphere. Perpendicular to the axis of rotation 32 of the threaded shank 4 the cross-section of the portion of the inner end 8 opposite the threaded part of threaded shank 4 is a regular polygon advantageously hexagon that follows the curvature of the sphere (FIGS. 53-56). The inner surface 15 of the intermediate piece 7 forms a sphere shell (FIG. 52). At the end 9 of insertion piece 6 a sphere shell-like seat is formed whose cross-section perpendicular to the axis of symmetry 25 of insertion piece 6 is a regular polygon, the number of the angles of the polygon equals to the number of the angles of the regular polygon formed on the portion of the inner end 8 of threaded shank 4 opposite the threaded part of threaded shank 4 (FIGS. 48-51). In the surface of the intermediate piece 7 opposite the implant 2 a bore-hole 14 is provided in which the threaded portion of the threaded shank 4 is led through. The inner end 8 of the threaded shank 4 is placed between the inner surface 15 of the intermediate piece 7 and the end 9 of the insertion piece 6 (FIGS. 58 and 61). The intermediate piece 7 and the insertion piece 6 are attached to each other in a releasable or un-releasable joint 21 so that tight but tiltable movement of the threaded shank 4 is ensured (FIGS. 57, 59 and 60). The fixing unit 3 is mounted in the implant 2 through a releasable joint. FIGS. 62-64 show the engagement between fixing unit 3 and dental device 31. During mounting fixing unit 3 is first placed in implant 2. This assembly is driven into periodontium 1 (not shown in the Figures) and the threaded shank 4 is set in the required direction. Then sample is taken in the known manner and dental device 31 is made which is then placed on threaded shank 4 and secured by means of the fixing female screw 26.

In this solution the portion of the inner end 8 of threaded shank 4 opposite the threaded part of it is shaped similarly to the head of a rounded torx screwdriver or Allen-key or any polygonal screwdriver. The insertion piece 6 is provided with a spherical seat 33 for receiving the inner end 8 of threaded shank 4.

Screw drivers for socket head screws (for example Allen head screws, torx screws) the end of which is rounded and can be used for driving the screw in or out in a direction that deviates even 30° from the axis of symmetry of the screw are known. The solutions according to the invention use this method. That is, the end 9 of the insertion piece 6 (FIGS. 18, 24, 51) and/or the outer spherical surface 10 and/or the inner spherical surface 11 of the threaded shank 4 (FIGS. 16, 25) and/or the inner surface 15 of the intermediate piece 7 (FIGS. 11, 27, 32, 52) are formed similarly to these socket heads or screw drivers. Tight connection between insertion piece 6 and threaded shank 4 is ensured by the inner surface 15 formed at the upper end 13 of intermediate piece 7 (FIGS. 11, 27, 32, 52) in such a way that moving of threaded shank 4 is enabled. The threaded shank 4 is led through the bore-hole 14 of the intermediate piece 7. The size of the bore-hole 14 is determined so that the deviation angle α of the threaded shank 4 is at least 0°-25° from the axis of symmetry 25 of the bore-hole 14 of the intermediate piece 7 in all direction. This solution ensures that threaded shank 4 can also be rotated when it is tilted at angle a (FIG. 4).

Owing to the socket head formation axial rotation of the threaded shank 4 is prevented while its tilting movement relative to its axis is enabled. Thus fixing female screw 26 can be screwed up on the threaded shank 4 in such a manner that rotation of the threaded shank 4 is prevented (FIGS. 23, 28, 47, 64). Insertion piece 6 is attached to intermediate piece 7 through un-releasable joint 21 (FIG. 24) or to implant 2 in a form fitting manner. In this latter case the lower part of insertion piece has the form of a polygon 29 (FIG. 5) which can be received in a corresponding seat 30 provided inside implant 2 (FIG. 2).

FIGS. 65-67 show the tool 23 which can be used for inserting implant 2 provided with fixing unit 3 in periodontium 1 according to the invention.

Insertion of fixing unit 3 into implant 2 can be made easier if the outer surface of the upper end 13 of intermediate piece 7 has e.g. flat sides 22 (FIGS. 32, 41) or a suitable recess (it is not shown) so that by means of a properly designed tool the fixing element 5 can be screwed in the periodontium 1.

To this a tool 23 is provided which has a head matching to the flat sides 22. In order to prevent tool 23 from accidental coming off the intermediate piece 7 a threaded fixing element 24 is placed inside tool 23. This threaded fixing element 24 connects tool 23 to threaded shank 4 through screw joint in this manner tool 23 is not able to come off the intermediate piece 7. Threaded fixing element 24 can be rotated independently of tool 23 and is adapted to suitably secure tool 23 (FIGS. 65-67). Advantageously, dental device 31 can be fixed to implant 2 by means of fixing nut 26 (FIGS. 23, 28, 47, 64). Since the method for fixing the dental device onto the implant is well known, details of it is not given in this description.

The advantage of the fixing unit according to the invention is that by making the threaded shank tiltable the dental devices can be fixed in the mouth in such a manner that the angle of the dental device can be adjusted relative to the direction of the implant. The bore-holes of the screws are provided on a less visible surface of the dental device thereby a more natural appearance is achieved. The central point of the bore-hole of the intermediate piece lies in the central point of the supporting surface of the implant, in this way the position of the screw hole in the dental device can easily be determined. The fixing unit according to the invention can be used not only with newly made implants but also with implants inserted earlier. It can be used in case of a single bridge or even in case of a fourteen-piece bridgework. It can be used for fixing a dental device, crown provided with an arched screw channel realization of which was described in an earlier invention of the present inventors. It can fulfil the prosthetic requirements.

The fixing unit according to the invention is a universal structure which can be adjusted continuously. It can also be used for a screwed single bridge not only in case of bridgeworks where the correct direction is ensured at least by two fixing points.

1. Dental device fixing unit secured into an implant built in the periodontium the angular position of which can be adjusted optionally, said fixing unit (3) comprises a threaded shank (4) tiltable in all direction projecting from the implant (2) and a fixing element (5) for securing said threaded shank (4) to the implant (2), said fixing element (5) consists of an insertion piece (6) and an intermediate piece (7) provided with a bore-hole (14) in which said threaded shank (4) is led through in order to secure said insertion piece (6) to the implant (2), the end (9) of said insertion piece (6) and the inner end (8) of said threaded shank (4) are attached to each other in a swivelable manner, said inner end (8) of said threaded shank (4) is positioned between said end (9) of said insertion piece (6) and the upper end (13) of said intermediate piece (7), characterized in that said fixing unit (3) is secured in the implant (2) by screw joint in such a manner that the core diameter (16) of the threads (20) provided on said intermediate piece (7) is at least 0.1 mm less than the nominal diameter (17) of the female thread (28) provided in the implant (2), and prior to placement of the implant (2) provided with said fixing unit (3) vulcanized, biocompatible silicone (18) is filled between said intermediate piece (7) and the implant (2).

2. Fixing unit according to claim 1 characterized in that said core diameter (16) of said threads (20) formed on said intermediate piece (7) is 0.1-0.3 mm less than the nominal diameter (17) of said female threads formed in the implant (2) and to fill said biocompatible silicone (18) a channel (27) is formed in implant (2).

3. Dental device fixing unit secured into an implant built in the periodontium the Angular position of which can be adjusted optionally, said fixing unit (3) comprises a threaded shank (4) projecting from the implant (2) and a fixing element (5) for securing said threaded shank (4) to the implant (2) characterized in that said fixing element (5) consists of an insertion piece (7) and an intermediate piece (6), the end (9) of the insertion piece (6) is semi-spherical, the inner end (8) of said threaded shank (4) is a sphere shell (12) the inner spherical surface (11) of which is widened towards said insertion piece (6), the cross-section of the outer spherical surface (10) of said sphere shell (12) perpendicular to the axis of rotation (32) of said threaded shank (4) is a regular polygon, advantageously hexagon that follows the curvature of the sphere, the inner surface (15) of said intermediate piece (7) is a sphere-like shell whose cross-section perpendicular to the axis of symmetry (25) of said intermediate piece (7) is a regular polygon that follows the curvature of the sphere-like shell, the number of the angles of the polygon equals to the number of the angles of the regular polygon formed at said inner end (8) of said threaded shank (4), further, in the surface of said intermediate piece (7) opposite the implant (2) a bore-hole (14) is provided in which the threaded portion of said threaded shank (4) is led through, said inner end (8) of said threaded shank (4) is placed between said inner surface (15) of said intermediate piece (7) and said end (9) of said insertion piece (6) and said intermediate piece (7) and said insertion piece (6) are attached to each other through a releasable or un-releasable joint (21) so that tight but tiltable movement of said threaded shank (4) is ensured, further, said fixing unit (3) is mounted in the implant (2) preferably through a releasable joint.

4. Fixing unit according to claim 3 characterized in that said end (9) of said insertion piece (6) is shaped similarly to the head of a rounded torx screwdriver or Allen-key or any polygonal screwdriver, said inner end (8) of said threaded shank (4) is provided with a spherical seat for receiving said end (9) of said insertion piece (6).

5. Dental device fixing unit secured into an implant built in the periodontium the angular position of which can be adjusted optionally, said fixing unit (3) comprises a threaded shank (4) projecting from the implant (2) and a fixing element (5) for securing said threaded shank (4) to the implant (2) characterized in that said fixing element (5) consists of an insertion piece (7) and an intermediate piece (6), the end (9) of said insertion piece (6) is flat, the inner end (8) of said threaded shank (4) forms a sphere-like body whose cross-section perpendicular to the axis of rotation (32) of said threaded shank (4)—at least at the hemispherical portion near the threaded part of said threaded shank 4—is a regular polygon advantageously hexagon that follows the curvature of the sphere, and the portion of said inner end (8) opposite the threaded part of said threaded shank (4) forms a regular segment of a sphere, at most a hemisphere, the inner surface (15) of said intermediate piece (7) is a sphere-like shell whose cross-section perpendicular to the axis of symmetry (25) of said intermediate piece (7) is a regular polygon that follows the curvature of the sphere-like shell, the number of the angles of the polygon equals to the number of the angles of the regular polygon formed at said inner end (8) of said threaded shank (4), in the surface of said intermediate piece (7) opposite the implant (2) a bore-hole (14) is provided in which the threaded portion of said threaded shank (4) is led through, said inner end (8) of said threaded shank (4) is placed between said inner surface (15) of said intermediate piece (7) and said end (9) of said insertion piece (6), between said inner end (8) of said threaded shank (4) and said end (9) of said insertion piece (6) vulcanized, biocompatible silicone (18) is filled, further, said intermediate piece (7) and said insertion piece (6) are connected to each other through releasable or un-releasable joint (21) so that tight but tiltable movement of said threaded shank (4) is ensured, and said fixing unit (3) is secured in implant (2) through releasable joint.

6. Dental device fixing unit secured into an implant built in the periodontium the angular position of which can be adjusted optionally, said fixing unit (3) comprises a threaded shank (4) projecting from the implant (2) and a fixing element (5) for securing said threaded shank (4) to the implant (2) characterized in that said fixing element (5) consists of an insertion piece (7) and an intermediate piece (6), the inner end (8) of said threaded shank (4) is formed as a sphere-like body, at least the portion of it facing the threaded part of said threaded shank (4) is formed as a regular sphere, perpendicular to the axis of rotation (32) of said threaded shank (4) the cross-section of the portion of said inner end (8) opposite the threaded part of said threaded shank (4) is a regular polygon advantageously hexagon that follows the curvature of the sphere, the inner surface (15) of said intermediate piece (7) forms a sphere shell, at the end (9) of said insertion piece (6) a sphere shell-like spherical seat (33) is formed whose cross-section perpendicular to the axis of symmetry (25) of said insertion piece (6) is a regular polygon, the number of the angles of the polygon equals to the number of the angles of the regular polygon formed on the portion of said inner end (8) of said threaded shank (4) opposite the threaded part of said threaded shank (4), further, in the surface of said intermediate piece (7) opposite the implant (2) a bore-hole (14) is provided in which the threaded portion of said threaded shank (4) is led through, said inner end (8) of said threaded shank (4) is placed between said inner surface (15) of said intermediate piece (7) and said end (9) of said insertion piece (6), said intermediate piece (7) and said insertion piece (6) are attached to each other in a releasable or un-releasable joint (21) so that tight but tiltable movement of said threaded shank (4) is ensured, and said fixing unit (3) is mounted in implant (2) through a releasable joint.

7. Fixing unit according to any of claims 3-6 characterized in that said fixing unit (3) is secured to the implant (2) by screw joint in such a manner that the core diameter (16) of the threads provided on said intermediate piece (7) is at least 0.1 mm less than the nominal diameter (17) of the female threads (28) provided in the implant (2), further, prior to placing the implant (2)—provided with the fixing unit—in the periodontium (1), vulcanized, biocompatible silicone (18) is filled between said intermediate piece (7) and the implant (2).

8. Fixing unit according to any of claims 3-6 characterized in that said insertion piece (6) is fixed in the implant (2) through threaded joint (19) provided on the end of said insertion piece (6) projecting over said intermediate piece (7) or through threads (20) formed on the outer surface of said intermediate piece (7).

9. Fixing unit according to any of claims 3-6 characterized in that said intermediate piece (7) is fixed in the implant (2) through threaded joint (19) provided on the end of said insertion piece (6) projecting over said intermediate piece (7), said insertion piece (6) and said intermediate piece (7) are attached to each other through un-releasable joint (21).

10. Fixing unit according to any of claims 5-8 characterized in that said inner end (8) of said threaded shank (4) is shaped similarly to the head of a rounded torx screwdriver or Allen-key or any polygonal screwdriver.

11. Fixing unit according to any of claims 3, 5, 7-10 characterized in that said inner surface (15) of the upper end (13) of said intermediate piece (7) is provided with a spherical seat which is able to receive a torx or Allen screw or any polygonal screw.

12. Fixing unit according to any of claims 6-9 characterized in that the surface of said spherical seat (33) provided in said end (9) of said insertion piece (6) is formed to receive a torx or Allen screw or any polygonal screw.

13. Fixing unit according to any of claims 3-12 characterized in that the outer surface of said upper end (13) of said intermediate piece (7) is preferably provided with flat sides (22) or a suitable recess so that by means of a properly designed tool said fixing element (5) can be screwed in the periodontium (1).

14. Fixing unit according to claim 13 characterized in that for placing said fixing element (5) in the periodontium (1) the outer surface of said upper end (13) of said intermediate piece (7) is provided with flat sides (22) and the properly designed tool (23) has a head matching to the flat sides (22) and inside said tool (23) a threaded fixing element (24) is arranged through which said tool (23) can be fixed to said threaded shank (4).

15. Fixing unit according to any of claims 3-14 characterized in that the size of said bore-hole (14) provided on said intermediate piece (7) is determined so that said threaded shank (4) of said fixing element (5) can deviate at an angle (α) from the axis of symmetry (25) of said bore-hole (14) in all direction, wherein said angle (α) is at least 0°-25°.
